(19) United States
(12) Patent Application Publication
(10) Pub. No.: US 2025/0127224 A1
(43) Pub. Date: Apr. 24, 2025

(54) ATOMIZER, ATOMIZATION CORE, AND HEATING MEMBER THEREOF

(71) Applicant: SMOORE INTERNATIONAL HOLDINGS LIMITED, George Town (KY)

(72) Inventors: Wei WANG, Shenzhen (CN); Ming LYU, Shenzhen (CN); Mingda ZHU, Shenzhen (CN)

(21) Appl. No.: 18/922,064

(22) Filed: Oct. 21, 2024

(30) Foreign Application Priority Data
Oct. 24, 2023 (CN) 202311392294.2

(51) Int. Cl. A24F 40/46; A24F 40/10; A24F 40/44

(52) U.S. Cl. CPC A24F 40/46; A24F 40/10; A24F 40/44

(57) ABSTRACT

A heating member for heating an aerosol-forming material includes: a first heating layer having a first surface and a second surface opposite the first surface; and a second heating layer arranged on the first heating layer and at least partially covering the first surface and/or the second surface. A temperature coefficient of resistance of the first heating layer is greater than a temperature coefficient of resistance of the second heating layer.

### CROSS-REFERENCE TO PRIOR APPLICATION

Priority is claimed to Chinese Patent Application No. 202311392294.2, filed on Oct. 24, 2023, the entire disclosure of which is hereby incorporated by reference herein.

### FIELD

The present disclosure relates to the field of electronic atomizer technologies, and in particular, to an atomizer, an atomization core, and a heating member thereof.

### BACKGROUND

In existing electronic atomization devices, an aerosol-forming material is generally atomized in a resistance heating manner. At present, commonly used resistance heating structures are mainly divided into a thick film, a thin film, and a metal sheet/mesh. The metal sheet or the metal mesh belongs to a block-shaped material, and has a better density than a film system, so that the metal sheet/mesh has better consistency and reliability in terms of materials. At present, commonly used mesh materials mainly include an electrothermal alloy (for example, a nickel-base alloy such as FeCrAl or NiCr, this material has good high-temperature resistance but a temperature coefficient of resistance of the material is generally low and is less than 300 ppm/° C., which is mainly used for an electronic atomization device without a temperature control requirement abroad) and a steel material (mainly a stainless steel system with a high temperature coefficient of resistance that is greater than 500 ppm/° C. but limited high-temperature resistance performance, which is used for an electronic atomization device with a temperature control requirement).

At present, during normal operation of an electronic atomization device, the temperature of a resistance heating component generally ranges from 300° C. to 400° C. However, in a heating and atomization process, in a case that e-liquid supplying is not sufficient, a heating film may be dry heated and the temperature may even reach 1000° C. or higher, leading to serious influence on a non-electrothermal alloy material with limited high-temperature resistance performance.

### SUMMARY

In an embodiment, the present disclosure provides a heating member for heating an aerosol-forming material, the heating member comprising: a first heating layer comprising a first surface and a second surface opposite the first surface; and a second heating layer arranged on the first heating layer and at least partially covering the first surface and/or the second surface, wherein a temperature coefficient of resistance of the first heating layer is greater than a temperature coefficient of resistance of the second heating layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization device according to the present disclosure;

FIG. 2 is a schematic structural diagram of a longitudinal section of an atomizer according to the present disclosure;

FIG. 3 is a schematic structural diagram of an atomization core in an electronic atomization device according to the present disclosure;

FIG. 4 is a schematic structural diagram of a specific embodiment of a heating member according to the present disclosure;

FIG. 5 is a schematic structural diagram of another specific embodiment of a heating member according to the present disclosure;

FIG. 6 (a) is an SEM diagram of a first heating layer without a NiCrAlY coating after high-temperature heating;

FIG. 6 (b) is an SEM diagram of a heating member made of a first heating layer with a NiCrAlY coating after high-temperature heating;

FIG. 7 (a) is an SEM diagram of an independent first heating layer after high-temperature heating; and

FIG. 7 (b) is an SEM diagram of a heating member made of a second heating layer, a first heating layer, and a third heating layer through stacking and pressing after high-temperature heating.

### DETAILED DESCRIPTION

In an embodiment, the present disclosure provides an electronic atomization device, an atomizer, an atomization core, and a heating member thereof, to resolve the problem of poor high-temperature resistance performance of a heating member in the related art.

To resolve the foregoing technical problems, a first technical solution adopted in the present disclosure is to provide a heating member. The heating member is configured to heat an aerosol-forming material, and the heating member includes: a first heating layer, including a first surface and a second surface opposite to the first surface; and a second heating layer, arranged on the first heating layer and at least partially covering the first surface and/or the second surface, where a temperature coefficient of resistance of the first heating layer is greater than a temperature coefficient of resistance of the second heating layer.

The heating member further includes a third heating layer, where the third heating layer at least partially covers the surface of the first heating layer not covered by the second heating layer.

The second heating layer totally covers the first surface, and the third heating layer totally covers the second surface.

The second heating layer is arranged on the entire outer surface of the first heating layer. The thickness of each of the second heating layer and/or the third heating layer ranges from 1 μm to 50 μm; and preferably, the thickness of each of the second heating layer and/or the third heating layer ranges from 3 μm to 10 μm.

The thickness of the heating member ranges from 50 μm to 150 μm; and preferably, the thickness of the heating member ranges from 70 μm to 100 μm.

The thickness of the first heating layer accounts for 10% to 80% of the thickness of the heating member.

Each of the second heating layer and/or the third heating layer is a material containing an aluminum element; and preferably, each of the second heating layer and/or the third heating layer is an alloy containing an aluminum element.

The material containing an aluminum element includes at least one of Al₂O₃, NiAl, NiCrAl, NiCrAlY, or FeCrAl.

The temperature coefficient of resistance of the first heating layer is not less than 800 ppm/° C.; a range of a temperature coefficient of resistance of the heating member is 300 ppm/° C. to 1450 ppm/° C.; and a range of a resistivity of the heating member is 0.76 (2 cm to 1.27 Ω·cm.

To resolve the foregoing technical problems, a second technical solution adopted in the present disclosure is to provide an atomization core. The atomization core includes: a porous substrate, including a liquid absorbing surface and an atomization surface; and a heating member, arranged on the atomization surface of the porous substrate, where the heating member is the heating member described above.

To resolve the foregoing technical problems, a third technical solution adopted in the present disclosure is to provide an atomizer. The atomizer includes: a housing, including an accommodating cavity, where the accommodating cavity is configured to accommodate an aerosol-forming material; and an atomization core, arranged in the accommodating cavity, where the atomization core is configured to heat the aerosol-forming material; and the atomization core is the atomization core described above.

To resolve the foregoing technical problems, a fourth technical solution adopted in the present disclosure is to provide an electronic atomization device. The electronic atomization device includes a power supply assembly and the atomizer described above, where the power supply assembly is configured to supply power to the atomizer.

Beneficial effects of the present disclosure are as follows: Different from the related art, an electronic atomization device, an atomizer, an atomization core, and a heating member thereof are provided. The heating member includes: a first heating layer, including a first surface and a second surface opposite to the first surface; and a second heating layer, arranged on the first heating layer and at least partially covering the first surface and/or the second surface, where a temperature coefficient of resistance of the first heating layer is greater than a temperature coefficient of resistance of the second heating layer. In this application, the second heating layer with high high-temperature resistance performance is arranged on the first heating layer with a large temperature coefficient of resistance and limited high-temperature resistance performance to form a composite heating member, and high-temperature resistance performance of the heating member is improved through the second heating layer, so that the heating member has good high-temperature resistance performance and high temperature controllable performance.

In the accompanying drawings: 100—Electronic atomization device; 1—Atomizer; 11—Housing; 110—Accommodating cavity; 12—Atomization core; 121—Porous substrate; 122—Heating member; 21—First heating layer; 21a—First surface; 21b—Second surface; 22—Second heating layer; 23—Third heating layer; 24—Atomization surface; 25—Liquid absorbing surface; and 2—Power supply assembly.

The following describes solutions in the embodiments of the present disclosure in detail with reference to the accompanying drawings.

In the following description, for the purpose of description rather than limitation, specific details such as specific system structures, interfaces, and technologies are proposed to thoroughly understand the present disclosure.

The technical solutions in the embodiments of the present disclosure are clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

The terms “first”, “second”, and “third” in the present disclosure are merely intended for a purpose of description, and shall not be understood as indicating or implying relative importance or implicitly indicating a quantity of indicated technical features. Therefore, features defined by “first”, “second”, or “third” may explicitly or implicitly include at least one of the features. In the description of the present disclosure, unless otherwise specifically defined, “a plurality of” means at least two, for example, two, three, and the like. All directional indications (for example, upper, lower, left, right, front, and rear) in the embodiments of the present disclosure are merely used for explaining relative position relationships, movement situations, or the like between various components in a specific posture (as shown in the accompanying drawings). If the specific posture changes, the directional indications change accordingly. In addition, the terms “include”, “have”, and any variant thereof are intended to cover non-exclusive inclusion. For example, a process, method, system, product, or device that includes a series of steps or units is not limited to the listed steps or units, but further optionally includes steps or units that are not listed, or further optionally includes other steps or units that are intrinsic to the process, method, product, or device.

“Embodiment” mentioned in this specification means that specific features, structures, or characteristics described with reference to the embodiment may be included in at least one embodiment of the present disclosure. The term appearing at different positions of this specification may not refer to the same embodiment or an independent or alternative embodiment that is mutually exclusive with another embodiment. A person skilled in the art explicitly or implicitly understands that the embodiments described in this specification may be combined with other embodiments.

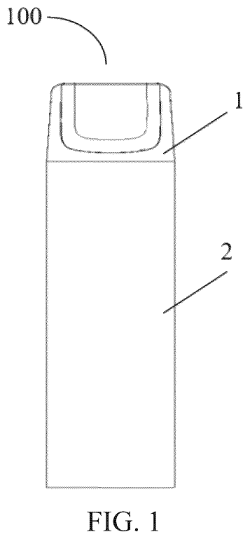

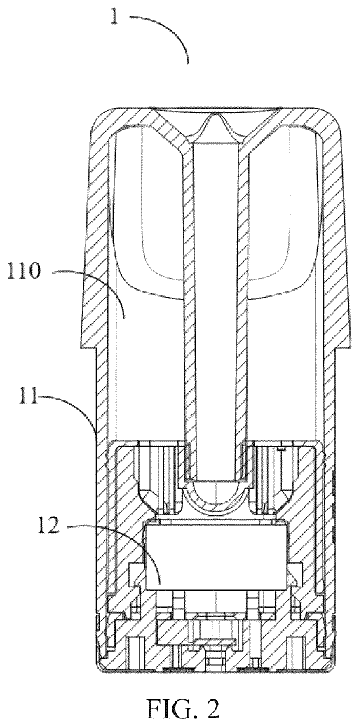

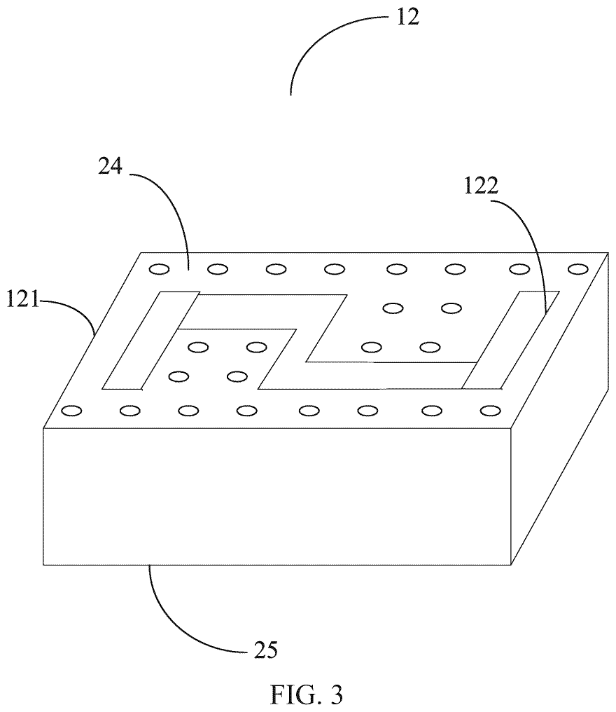

Referring to FIG. 1 to FIG. 3, FIG. 1 is a schematic structural diagram of an electronic atomization device according to the present disclosure; FIG. 2 is a schematic structural diagram of a longitudinal section of an atomizer according to the present disclosure; and FIG. 3 is a schematic structural diagram of an atomization core in an electronic atomization device according to the present disclosure.

An electronic atomization device 100 provided in the embodiments include a power supply assembly 2 and an atomizer 1 that are connected to each other. The power supply assembly 2 is configured to supply power to the atomizer 1. The atomizer 1 is configured to store an aerosol-forming material and heat the aerosol-forming material to form an aerosol that can be inhaled by a user, where the aerosol-forming material may be a liquid substrate such as medicinal liquid or plant leaf liquid; and the atomizer 1 may be applied to different fields such as medical care, cosmetology, and electronic aerosolization. The atomizer 1 and the power supply assembly 2 may be integrally arranged or may be detachably connected to each other, which is designed according to a specific requirement.

In the present disclosure, the atomizer 1 may also be directly referred to as the electronic atomization device 100, and the two are equivalent. The atomizer 1 comprise a power supply assembly 2, wherein the power supply assembly 2 is configured to supply power to the atomizer 1.

The atomizer 1 includes a housing 11 and an atomization core 12. The housing 11 includes an accommodating cavity 110, and the accommodating cavity 110 is configured to accommodate the aerosol-forming material. The atomization core 12 is arranged in the accommodating cavity 110, and the atomization core 12 is configured to heat the aerosol-forming material. The atomization core 12 heats the aerosol-forming material, to volatilize any one component of the aerosol-forming material to form the aerosol to be inhaled by the user. The atomization core 12 is electrically connected to the power supply assembly 2, to heat the aerosol-forming material. The atomization core 12 includes a porous substrate 121 and a heating member 122. The porous substrate 121 includes a liquid absorbing surface 25 and an atomization surface 24. The surface of the porous substrate 121 that comes in contact with the aerosol-forming material in the accommodating cavity 110 is the liquid absorbing surface 25. The surface of the porous substrate 121 that is configured to heat the aerosol-forming material is the atomization surface 24. The heating member 122 is arranged on the atomization surface 24 of the porous substrate 121. The porous substrate 121 is configured to guide the aerosol-forming material in the accommodating cavity 110 to the surface of the porous substrate 121 on which the heating member 122 is arranged. The heating member 122 is configured to heat the aerosol-forming material to generate an aerosol. The heating member 122 may be a metal sheet, a metal mesh, or a metal strip. In an embodiment, the porous substrate 121 may be a ceramic porous member. The heating member 122 may be an S-shaped metal strip or a grid-shaped metal mesh, and pins are provided at two ends respectively. The two ends of the heating member 122 are connected to a positive electrode and a negative electrode of the power supply assembly 2 through the pins. A part of the heating member 122 is embedded in the porous substrate 121.

The heating member 122 includes a first heating layer 21 and a second heating layer 22. The first heating layer 21 includes a first surface 21a and a second surface 21b opposite to the first surface. In this embodiment, the first heating layer 21 is of a sheet structure. For example, the first heating layer 21 is a metal sheet. A material of the first heating layer 21 is stainless steel. A temperature coefficient of resistance of the stainless steel is not less than 500 ppm/° C. In this embodiment, a temperature coefficient of resistance of the first heating layer 21 is not less than 800 ppm/° C. Specifically, the stainless steel includes at least one of stainless steel 403, stainless steel 304, stainless steel 316, or stainless steel 904. The stainless steel system has a high temperature coefficient of resistance, but has limited high-temperature resistance performance.

The second heating layer 22 is arranged on the first heating layer 21 and at least partially covers the first surface 21a and/or the second surface 21b. The high-temperature resistance performance of the second heating layer 22 is better than the high-temperature resistance performance of the first heating layer 21, and the temperature coefficient of resistance of the first heating layer 21 is greater than a temperature coefficient of resistance of the second heating layer 22. The second heating layer 22 with high high-temperature resistance performance is arranged on the first heating layer 21 with a large temperature coefficient of resistance and limited high-temperature resistance performance to form the heating member 122, so that the obtained heating member 122 has good high-temperature resistance performance and high temperature controllable performance.

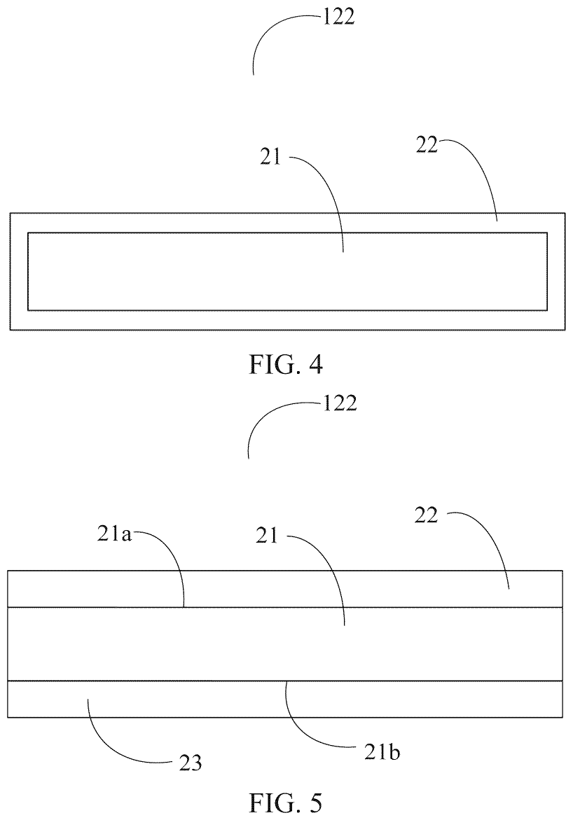

Referring to FIG. 4, FIG. 4 is a schematic structural diagram of a specific embodiment of a heating member according to the present disclosure.

In an embodiment, the second heating layer 22 is a film layer covering the outer surface of the first heating layer 21. The second heating layer 22 is formed on the outer surface of the first heating layer 21 in one or more manners of spin coating, hot pressing, electrostatic spray coating, plasma spraying, slot coating, anilox coating, intaglio printing, micro-gravure coating, comma scraper coating, screen printing, vapor deposition, vacuum coating, and thermal spraying. In this embodiment, the second heating layer 22 is arranged on the outer surface of the first heating layer 21 in a vapor deposition or spraying manner.

Specifically, for the second heating layer 22, the second heating layer 22 is deposited on the first surface 21a and/or the second surface 21b of the first heating layer 21 in a physical vapor deposition coating manner. That is, a film layer is formed on the surface of the first heating layer 21. In another embodiment, the second heating layer 22 is deposited on part of the first surface 21a and/or the second surface 21b of the first heating layer 21 in a physical vapor deposition coating manner, so that the second heating layer 22 at least partially covers the first surface 21a and/or the second surface 21b. That is, a film layer is formed on at least part of the surface of the first heating layer 21.

In this embodiment, to prevent the aerosol-forming material from being in contact with the first heating layer 21 and corroding the heating layer 21, the second heating layer 22 covers the entire first surface 21a and the entire second surface 21b opposite to the first surface, and all side surfaces of the first heating layer 21 in a physical vapor deposition coating manner.

In another embodiment, the second heating layer 22 is of a sheet structure. The second heating layer 22 and the first heating layer 21 are connected to each other in a manner of soldering or mechanical pressing to form the heating member 122.

Referring to FIG. 5, FIG. 5 is a schematic structural diagram of another specific embodiment of a heating member according to the present disclosure.

The heating member 122 further includes a third heating layer 23, where the third heating layer 23 at least partially covers the surface of the first heating layer 21 not covered by the second heating layer 22.

In an embodiment, the second heating layer 22 is deposited on the first surface 21a or the second surface 21b of the first heating layer 21 in a physical vapor deposition coating manner, and the third heating layer 23 is stacked on the surface of the first heating layer 21 on which the second heating layer 22 is not deposited and processed through soldering or mechanical pressing and patterning, to obtain the heating member 122. The second heating layer 22 is of a film structure, and the third heating layer 23 is of a sheet structure.

In another embodiment, the second heating layer 22 is stacked on the first surface 21a or the second surface 21b of the first heating layer 21 and is processed through soldering or mechanical pressing and patterning; and the third heating layer 23 is deposited in a physical vapor deposition coating manner on the surface of the first heating layer 21 on which the second heating layer 22 is stacked, to obtain the heating member 122. The second heating layer 22 is of a sheet structure, and the third heating layer 23 is of a film structure.

In another embodiment, the second heating layer 22, the first heating layer 21, and the third heating layer 23 are sequentially stacked and processed through soldering or mechanical pressing and patterning, to obtain the heating member 122. Each of the first heating layer 22 and the third heating layer 23 is of a sheet structure.

A material of the second heating layer 22 and a material of the third heating layer 23 may be different or the same. Each of the second heating layer 22 and/or the third heating layer 23 is a high-temperature resistant material containing an aluminum element. In this embodiment, each of the second heating layer 22 and/or the third heating layer 23 is a high-temperature resistant alloy containing an aluminum element, and the alloy containing an aluminum element includes at least one of Al₂O₃, NiAl, NiCrAl, NiCrAlY, or FeCrAl. The thickness of the second heating layer 22 and the thickness of the third heating layer 23 may be the same or different.

In this embodiment, to ensure a production yield of the heating member 122, the material of the second heating layer 22 and the material of the third heating layer 23 are the same; and the thickness of the second heating layer 22 and the thickness of the third heating layer 23 are the same.

The thickness of each of the second heating layer 22 and/or the third heating layer 23 ranges from 1 μm to 50 μm. In this embodiment, the thickness of each of the second heating layer 22 and/or the third heating layer 23 ranges from 3 μm to 10 μm. Specifically, the thickness of the second heating layer 22 ranges from 3 μm to 10 μm; and/or the thickness of the third heating layer 23 ranges from 3 μm to 10 μm. Alternatively, the thickness of the second heating layer 22 and the thickness of the third heating layer 23 both range from 3 μm to 10 μm. For example, the thickness of the second heating layer 22 and/or the thickness of the third heating layer 23 may be 3 μm, 4 μm, 5 μm, 6 μm, 7 μm, 8 μm, 9 μm, 10 μm, or the like, or may be another value falling within the foregoing range, which is not limited herein.

In an embodiment, the thickness of the heating member 122 ranges from 50 μm to 150 μm. In this embodiment, the thickness of the heating member 122 ranges from 70 μm to 100 μm. For example, the thickness of the heating member 122 may be 70 μm, 80 μm, 90 μm, 100 μm, or the like. In this embodiment, the thickness of the first heating layer 21 accounts for 10% to 80% of the thickness of the heating member 122. That is, a ratio of the thickness of the first heating layer 21 to the thickness of the heating member 122 meets (0.1 to 0.8): 1. Specifically, the ratio of the thickness of the first heating layer 21 to the thickness of the heating member 122 may be 0.1:1, 0.2:1, 0.3:1, 0.4:1, 0.5:1, 0.6:1, 0.7:1, 0.8:1, or the like, or may be another value falling within the foregoing range, which is not limited herein. In this application, the high-temperature resistance performance and the temperature coefficient of resistance of the heating member 122 may be adjusted by controlling the ratio of the thickness of the first heating layer 21 to the thickness of the heating member 122, so that diversified requirements of users can be satisfied.

In an embodiment, a range of the temperature coefficient of resistance of the heating member 122 is 300 ppm/° C. to 1450 ppm/° C., and a range of a resistivity of the heating member 122 is 0.76 Ω·cm to 1.27 Ω·cm. For example, the temperature coefficient of resistance of the heating member 122 may be 800 ppm/° C., 900 ppm/° C., 1000 ppm/° C., 1100 ppm/° C., 1200 ppm/° C., 1300 ppm/° C., 1400 ppm/° C., or the like, or may be another value falling within the foregoing range, which is not limited herein. The resistivity of the heating member 122 may be 0.8 Ω·cm, 0.9 Ω·cm, 1.0 Ω·cm, 1.1 Ω·cm, 1.2 Ω·cm, or the like, or may be another value falling within the foregoing range, which is not limited herein.

In this embodiment, under a high temperature condition, in the first heating layer 21, a large amount of brittle iron-containing or chrome-containing oxide is precipitated into the aerosol-forming material. The second heating layer 22, the first heating layer 21, and the third heating layer 23 are sequentially stacked, pressed, and patterned to form the heating member 122, so that the heating member 122 is of a “sandwiched” stack structure. Specifically, the second heating layer 22 totally covers the first surface 21a of the first heating layer 21, and the third heating layer 23 totally covers the second surface 21b of the first heating layer 21. Under a high temperature condition, a dense oxygen-blocking oxide film is formed on the surface of the second heating layer 22 and the surface of the third heating layer 23 that are away from the first heating layer 21. The oxide film can prevent the heating member 122 from being in contact with the outside and being oxidized, so that iron-containing oxide and chrome-containing oxide are not formed, thereby maintaining the high-temperature resistance reliability of the heating member 122.

The heating member 122 has good high-temperature resistance performance. During preparation of the atomization core 12, the heating member 122 may be first mounted on the atomization surface 24 of the porous substrate 121, and then co-fired under a high temperature condition, thereby improving the structural stability of the atomization core 12. In this embodiment, since the heating member 122 has excellent high-temperature resistance performance, a co-firing temperature of the porous substrate 121 and the heating member 122 can be adapted to a higher temperature, and an adjustable range of a sintering temperature is increased. Specifically, during sintering, the co-firing temperature of the porous substrate 121 and the heating member 122 may exceed 1000° C.

In an embodiment, a metal mesh made of stainless steel 316 is selected as the first heating layer 21. The metal mesh has a resistivity of about 0.8 Ω·cm, a resistance value of about 0.9Ω, a temperature coefficient of resistance of about 1300 ppm/° C., and the thickness of 50 μm. A NiCrAlY coating with the thickness of 3 μm is deposited on the surface of the first heating layer 21 in a physical vapor deposition manner. The first heating layer 21 and the second heating layer 22 form the heating member 122, and the heating member 122 has a resistance value of 0.86Ω and a temperature coefficient of resistance of 1250 ppm/° C.

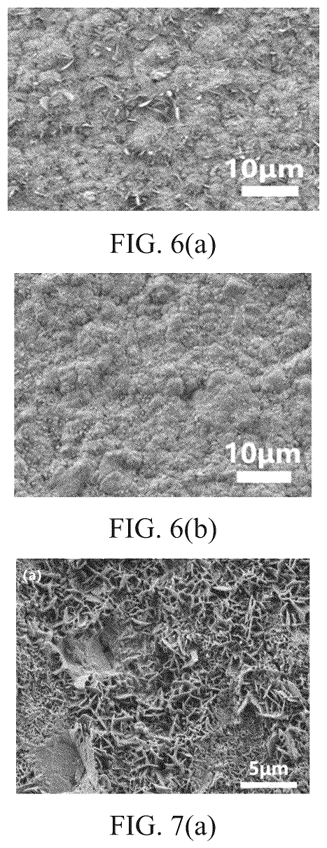

Referring to FIG. 6 (a) and FIG. 6 (b), FIG. 6 (a) is an SEM diagram of a first heating layer without a NiCrAlY coating after high-temperature heating; and FIG. 6 (b) is an SEM diagram of a heating member made of a first heating layer with a NiCrAlY coating after high-temperature heating.

Both a metal mesh made of the first heating layer 21 without the NiCrAlY coating and the heating member 122 made of the first heating layer 21 with the NiCrAlY coating are placed in air at 1000° C. for thermal treatment for one hour. Under a high temperature condition, a large amount of brittle sheet-like iron or chrome oxide is formed on the surface of the first heating layer 21 without the NiCrAlY coating, as shown in FIG. 6 (a), and the surface of the first heating layer 21 turns green. However, the surface of the first heating layer 21 with the NiCrAlY coating does not turn green, and the NiCrAlY coating on the surface of the first heating layer 21 forms a granular dense aluminum oxide film layer under a high temperature condition, as shown in FIG. 6 (b), which can effectively prevent the first heating layer 21 from being oxidized.

A shape and a size of the first heating layer 21 of the metal mesh made of stainless steel 316 are shown in Table 1.

TABLE 1

| | Line width of | Line width of | Lateral | | | |
|---|---|---|---|---|---|---|
| | the metal mesh | the metal mesh | gap of | Longitudinal | | |
| | (both sides of | (a middle | the | gap of the | | Resistance |
| Measurement | an electrode) | portion) | mesh | mesh | | value |
| position | (mm) | (mm) | (mm) | (mm) | Chamfer | (Ω) |
| 1 | 0.100 | 0.099 | 0.398 | 1.790 | 25.435 | 0.930 |
| 2 | 0.100 | 0.100 | 0.400 | 1.780 | 25.812 | 0.907 |
| 3 | 0.100 | 0.099 | 0.398 | 1.790 | 25.872 | 0.957 |
| 4 | 0.100 | 0.099 | 0.400 | 1.785 | 25.823 | 0.921 |

In another embodiment, a metal mesh made of stainless steel 430 is selected as the first heating layer 21. The metal mesh has a resistivity of about 0.6 Ω·cm, a temperature coefficient of resistance of about 1800 ppm/° C., and the thickness of 70 μm. A heating member 122 is obtained through mechanical pressing after a second heating layer 22 of a material of FeCrAl, a first heating layer 21 of a material of stainless steel 430, and a third heating layer 23 of a material of FeCrAl are stacked. The thickness of the heating member 122 is about 80 μm. The thickness of each of the second heating layer 22 and the third heating layer 23 is 20 μm, and the thickness of the first heating layer 21 is 40 μm. A resistivity of the heating member 122 is 1 Ω·cm, and a temperature coefficient of resistance of the heating member is about 1300 ppm/° C.

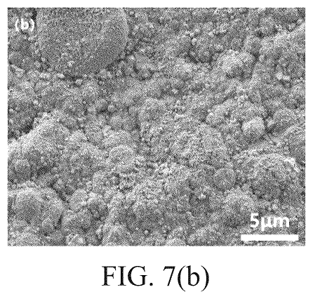

Referring to FIG. 7 (a) and FIG. 7 (b), FIG. 7 (a) is an SEM diagram of an independent first heating layer after high-temperature heating; and FIG. 7 (b) is an SEM diagram of a heating member made of a second heating layer, a first heating layer, and a third heating layer through stacking and pressing after high-temperature heating.

Both a metal mesh made of the independent first heating layer 21 and the heating member 122 obtained by stacking and pressing the second heating layer 22, the first heating layer 21, and the third heating layer 23 are placed in air at 1000° C. for thermal treatment for one hour. Under a high temperature condition, a large amount of brittle sheet-like iron or chrome oxide is formed on the surface of the independent first heating layer 21, as shown in FIG. 7 (a), and the surface of the independent first heating layer 21 turns green. However, the surface of the heating member 122 obtained by stacking and pressing the second heating layer 22, the first heating layer 21, and the third heating layer 23 does not turn green, and a granular dense aluminum oxide film layer is formed on the surface of the second heating layer 22 and the surface of the third heating layer 23, as shown in FIG. 7 (b), so that the heating member 122 can be effectively prevented from being oxidized, thereby ensuring the high-temperature resistance performance and the temperature controllable performance of the heating member 122.

The metal mesh made of stainless steel 430 is used as the first heating layer 21, and a shape and a size of the first heating layer 21 are shown in Table 2.

TABLE 2

| | Line width of | Line width of | Lateral | | | |
|---|---|---|---|---|---|---|
| | the metal mesh | the metal mesh | gap of | Longitudinal | | |
| | (both sides of | (a middle | the | gap of the | | Resistance |
| Measurement | an electrode) | portion) | mesh | mesh | | value |
| position | (mm) | (mm) | (mm) | (mm) | Chamfer | (Ω) |
| 1 | 0.090 | 0.090 | 0.400 | 1.790 | 25.574 | 0.808 |
| 2 | 0.090 | 0.090 | 0.400 | 1.790 | 25.489 | 0.745 |
| 3 | 0.090 | 0.089 | 0.400 | 1.790 | 25.672 | 0.706 |
| 4 | 0.090 | 0.090 | 0.398 | 1.787 | 25.673 | 0.705 |

The technical solutions of this application are described in detail below according to specific embodiments. Embodiment 1 A first heating layer 21, a second heating layer 22, and a third heating layer 23 are provided. A material of the first heating layer 21 is stainless steel 430, materials of both the second heating layer 22 and the third heating layer 23 are FeCrAl, and mechanical pressing is performed after the second heating layer 22, the first heating layer 21, and the third heating layer 23 are stacked to obtain a precursor.

Chemical etching treatment is performed on the precursor to obtain a grid-shaped heating member 122.

In this embodiment, the thickness of the heating member 122 is 70 μm, a resistivity of the heating member 122 is 1 Ω·cm, and a temperature coefficient of resistance is 1300 ppm/° C. The thickness of the first heating layer 21 accounts for 50% of the thickness of the heating member 122.

### Embodiment 2

A grid-shaped heating member 122 is obtained by using the same materials and steps as in Embodiment 1.

In this embodiment, the thickness of the heating member 122 is 100 μm, a resistivity of the heating member 122 is 0.76 Ω·cm, and a temperature coefficient of resistance is 1450 ppm/° C. The thickness of the first heating layer 21 accounts for 80% of the thickness of the heating member 122.

### Embodiment 3

A grid-shaped heating member 122 is obtained by using the same materials and steps as in Embodiment 1.

In this embodiment, the thickness of the heating member 122 is 80 μm, a resistivity of the heating member 122 is 1.2 (2 cm, and a temperature coefficient of resistance is 750 ppm/° C. The thickness of the first heating layer 21 accounts for 25% of the thickness of the heating member 122.

### Embodiment 4

A first heating layer 21, a second heating layer 22, and a third heating layer 23 are provided. A material of the first heating layer 21 is stainless steel 316, materials of both the second heating layer 22 and the third heating layer 23 are FeCrAl, and mechanical pressing is performed after the second heating layer 22, the first heating layer 21, and the third heating layer 23 are stacked to obtain a precursor.

Chemical etching treatment is performed on the precursor to obtain a grid-shaped heating member 122.

In this embodiment, the thickness of the heating member 122 is 70 μm, a resistivity of the heating member 122 is 1.1 Ω·cm, and a temperature coefficient of resistance is 1000 ppm/° C. The thickness of the first heating layer 21 accounts for 50% of the thickness of the heating member 122.

### Embodiment 5

A first heating layer 21, a second heating layer 22, and a third heating layer 23 are provided. A material of the first heating layer 21 is stainless steel 904, materials of both the second heating layer 22 and the third heating layer 23 are FeCrAl, and mechanical pressing is performed after the second heating layer 22, the first heating layer 21, and the third heating layer 23 are stacked to obtain a precursor.

Chemical etching treatment is performed on the precursor to obtain a grid-shaped heating member 122.

In this embodiment, the thickness of the heating member 122 is 100 μm, a resistivity of the heating member 122 is 1.27 (2 cm, and a temperature coefficient of resistance is 300 ppm/° C. The thickness of the first heating layer 21 accounts for 10% of the thickness of the heating member 122.

### Comparative Embodiment 1

The heating member 122 is of a single-layer structure. A material of the heating member 122 is stainless steel 430. The thickness of the heating member 122 is 70 μm, a resistivity of the heating member 122 is 0.6 Ω·cm, and a temperature coefficient of resistance is 1800 ppm/° C.

### Comparative Embodiment 2

The heating member 122 is of a single-layer structure. A material of the heating member 122 is stainless steel 316. The thickness of the heating member 122 is 70 μm, a resistivity of the heating member 122 is 0.8 Ω·cm, and a temperature coefficient of resistance is 1340 ppm/° C.

### Comparative Embodiment 3

The heating member 122 is of a single-layer structure. A material of the heating member 122 is stainless steel 904. The thickness of the heating member 122 is 70 μm, a resistivity of the heating member 122 is 0.95 $2 cm, and a temperature coefficient of resistance is 800 ppm/° C.

### Comparative Embodiment 4

The heating member 122 is of a single-layer structure. A material of the heating member 122 is FeCrAl. The thickness of the heating member 122 is 70 μm, a resistivity of the heating member 122 is 1.4 Ω·cm, and a temperature coefficient of resistance is less than 100 ppm/° C.

Performance detection is performed on the heating members 122 in the foregoing embodiments and the foregoing comparative embodiments. Specifically, the thickness of the heating member 122 and the thickness of each of the first heating layer 21, the second heating layer 22, and/or the third heating layer 23 in the heating member 122 are measured. The resistivity of the heating member 122 is tested by using a resistivity tester. Specifically, resistivities and temperature coefficients of resistance of the heating members 122 in the foregoing Embodiments and Comparative Embodiments are shown in Table 3.

TABLE 3

| | | Total thickness | Resistivity | Temperature |
|---|---|---|---|---|
| | | (μm) of the heating | (Ω · cm) of the | coefficient of |
| | Structure of the | member and ratio of | heating | resistance |
| Serial number | heating member | thickness of layers | member | (ppm/° C.) |
| Embodiment 1 | FeCrAl + Stainless | 70(1:2:1) | 1 | 1300 |
| | Steel 430 + FeCrAl | | | |
| Embodiment 2 | FeCrAl + Stainless | 100(1:8:1) | 0.76 | 1450 |
| | Steel 430 + FeCrAl | | | |
| Embodiment 3 | FeCrAl + Stainless | 80(3:2:3) | 1.2 | 750 |
| | Steel 430 + FeCrAl | | | |
| Embodiment 4 | FeCrAl + Stainless | 70(1:2:1) | 1.1 | 1000 |
| | Steel 316 + FeCrAl | | | |
| Embodiment 5 | FeCrAl + Stainless | 100(9:2:9) | 1.27 | 300 |
| | Steel 904 + FeCrAl | | | |
| Comparative | Stainless Steel 430 | 70 | 0.6 | 1500 |
| Embodiment 1 | | | | |
| Comparative | Stainless Steel 316 | 70 | 0.8 | 1300 |
| Embodiment 2 | | | | |
| Comparative | Stainless Steel 904 | 70 | 0.95 | 800 |
| Embodiment 3 | | | | |
| Comparative | FeCrAl | 70 | 1.4 | <100 |
| Embodiment 4 | | | | |

According to the heating members 122 prepared in Embodiments 1 to 5 of this application, three types of metal sheets are arranged in a stacked manner, so that the heat resistance performance of the heating member 122 can be enhanced, and the heating member 122 has excellent high-temperature resistance performance and a high temperature coefficient of resistance. The excellent resistivity enables the heating member 122 to generate more heat during heating, thereby improving the heating efficiency; and the high temperature coefficient of resistance enables the temperature of the heating member 122 to be controllable. The first heating layer 21 is covered by the second heating layer 22 and the third heating layer 23, so that a dense aluminum oxide film layer is formed on the surface of the heating member 122 under a high temperature condition, which can effectively prevent continuous oxidation of the heating member 122, thereby alleviating the problem that a large amount of brittle sheet-like iron or chrome oxide is easily formed on the heating member 122, and preventing the first heating layer 21 from being corroded by the aerosol-forming material.

In Embodiment 1, the heating member 122 obtained by using the composite mode of FcCrAl+stainless steel 430+FeCrAl can obtain a high resistivity and a high temperature coefficient of resistance, so that a temperature control function can be achieved while the heating efficiency is improved, and excellent overall performance is obtained.

In Embodiment 2, the heating member 122 obtained by using the composite mode of FeCrAl+stainless steel 430+FeCrAl can obtain a suitable resistivity and a high temperature coefficient of resistance, so that accurate temperature control can be achieved while the heating efficiency of the heating member 122 can be ensured, and dry heating is prevented.

In Embodiment 5, the heating member 122 obtained by using the composite mode of FeCrAl+stainless steel 904+FeCrAl can obtain an excellent resistivity and a low temperature coefficient of resistance. In this way, the heating member 122 can only ensure the heating efficiency of the heating member 122 but cannot take a temperature control function of the heating member 122 into account. In conclusion, in this application, by selecting the material of each of the heating layers and the thickness of each of the heating layers, design and value setting can be performed according to a requirement of a user, so that a series of heating members 122 with excellent performance can be obtained.

In an electronic atomization device 100 provided in this embodiment, a heating member 122 includes: a first heating layer 21, including a first surface 21a and a second surface 21b opposite to the first surface; and a second heating layer 22, arranged on the first heating layer 21 and at least partially covering the first surface 21a and/or the second surface 21b, where a temperature coefficient of resistance of the first heating layer 21 is greater than a temperature coefficient of resistance of the second heating layer 22. In this application, the second heating layer 22 with high high-temperature resistance performance is arranged on the first heating layer 21 with a large temperature coefficient of resistance and limited high-temperature resistance performance, and the second heating layer 22 covers the first surface 21a and the second surface 21b opposite to the first surface of the first heating layer 21 to form a composite heating member 122, so that the heating member 122 has good high-temperature resistance performance and high temperature controllable performance.

The foregoing merely describes implementations of the present disclosure but is not intended to limit the patent protection scope of the present disclosure. All equivalent structure or process changes made according to the content of this specification and accompanying drawings in the present disclosure or by directly or indirectly applying the present disclosure in other related technical fields shall fall within the patent protection scope of the present disclosure.

While the disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements. e.g., A and B. or the entire list of elements A, B and C.

What is claimed is:

1. A heating member for heating an aerosol-forming material, the heating member comprising:
a first heating layer comprising a first surface and a second surface opposite the first surface; and
a second heating layer arranged on the first heating layer and at least partially covering the first surface and/or the second surface,
wherein a temperature coefficient of resistance of the first heating layer is greater than a temperature coefficient of resistance of the second heating layer.

2. The heating member of claim 1, further comprising:
a third heating layer at least partially covering a surface of the first heating layer not covered by the second heating layer.

3. The heating member of claim 2, wherein the second heating layer totally covers the first surface, and
wherein the third heating layer totally covers the second surface.

4. The heating member of claim 2, wherein a thickness of each of the second heating layer and/or the third heating layer ranges from 1 μm to 50 μm.

5. The heating member of claim 1, wherein a thickness of the heating member ranges from 50 μm to 150 μm.

6. The heating member of claim 5, wherein a thickness of the first heating layer accounts for 10% to 80% of the thickness of the heating member.

7. The heating member of claim 1, wherein each of the second heating layer and/or the third heating layer comprises a material containing an aluminum element.

8. The heating member of claim 7, wherein the material containing the aluminum element comprises at least one of Al₂O₃, NiAl, NiCrAl, NiCrAlY, and FeCrAl.

9. The heating member of claim 1, wherein the temperature coefficient of resistance of the first heating layer is not less than 800 ppm/° C.

10. The heating member of claim 1, wherein a range of the temperature coefficient of resistance of the heating member is 300 ppm/° C. to 1450 ppm/° C.

11. The heating member of claim 1, wherein a range of a resistivity of the heating member is 0.76 Ω·cm to 1.27 Ω·cm.

12. An atomization core, comprising:
a porous substrate comprising a liquid absorbing surface and an atomization surface; and
the heating member of claim 1 arranged on the atomization surface of the porous substrate.

13. An atomizer, comprising:
a housing comprising an accommodating cavity configured to accommodate an aerosol-forming material; and
the atomization core of claim 12 arranged in the accommodating cavity, the atomization core being configured to heat the aerosol-forming material.

14. The atomizer of claim 1, comprising a power supply assembly, wherein the power supply assembly is configured to supply power to the atomizer.

15. The heating member of claim 4, wherein the thickness of each of the second heating layer and/or the third heating layer ranges from 3 μm to 10 μm.

16. The heating member of claim 5, wherein the thickness of the heating member ranges from 70 μm to 100 μm.

17. The heating member of claim 7, wherein each of the second heating layer and/or the third heating layer comprises an alloy containing an aluminum element.
